(19) United States
(12) Patent Application Publication
(10) Pub. No.: US 2009/0255126 A1
(43) Pub. Date: Oct. 15, 2009

(54) Lemon fork a salutary utensil for serving lemon wedges

(76) Inventor: Joy W. Whistle, Verona Beach, NY (US)

Correspondence Address: JOY W. WHISTLE, 6755 LAKE SHORE Rd. N., VERONA BEACH, NY, 13162-0460, US

(21) Appl. No.: 12/384,991

(22) Filed: Apr. 13, 2009

Related U.S. Application Data
(60) Provisional application No. 61/123,935, filed on Apr. 14, 2008.

(51) Int. Cl. A47J 43/28

(52) U.S. Cl. 30/123; 30/322

(57) ABSTRACT

Bar tenders and waitresses serve lemon with a beverage. There has been at least one case of polluted lemon wedges attributed to handling and numerous other cases of undesirable service.

The present invention features a salutary utensil for serving a lemon wedge without touching it. It is a lemon fork. It has tines and a slot at some angle to the tines. A server can fork a lemon wedge. Then orient the slot downward and place it on a glass. It is easy to use. It can be molded, machined or stamped.

### CROSS REFERENCE TO RELATED APPLICATIONS

None

### STATEMENT REGARDING FEDERALLY SPONSORED RESEARCH OR DEVELOPMENT

None.

### BACKGROUND OF THE INVENTION

There has been at least one case of polluted lemon wedges attributed to handling. I was served ½ a lemon wedge in ice tea. It is desirable to have a lemon wedge pierced before squeezing.

### BRIEF SUMMARY OF THE INVENTION

The object of this invention is offer a more salutary method of serving lemon wedges with a drink. It is a salutary utensil.

Tines are provided for engaging and piercing a lemon wedge.

A method of affixing it to a drinking vessel is included.

Serving is accomplished without touching the lemon wedge.

### BRIEF DESCRIPTION OF THE SEVERAL VIEWS OF THE DRAWING

Drawings of the lemon fork are shown in FIG. 1 and FIG. 2 on page 7

The lemon fork can be manufactured by machining, die set, clicker cut or molding.

FIG. 1 shows a design adept to all of the above.

FIG. 2 is a more fancy design suitable for molding only.

Items 1 and 2 point to special design features of the lemon forks shown in FIG. 1 and FIG. 2.

Item 1 points to a tine for insertion into a lemon wedge.

Item 2 designates a variable slot for engagement with a glass or other container.

FIG. 3 on page 8 is a 3D view of the lemon fork.

FIG. 4 on page 9 is a photo of a lemon wedge as served with a drink.

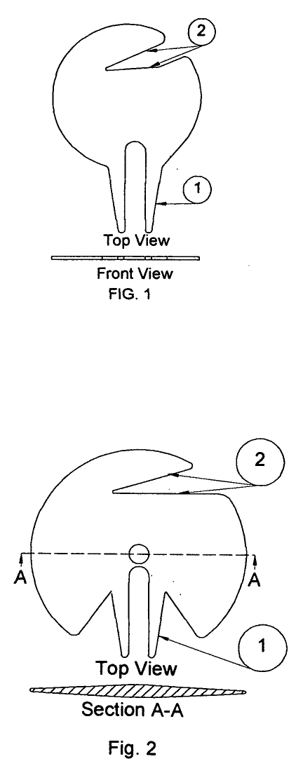

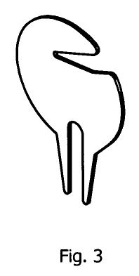

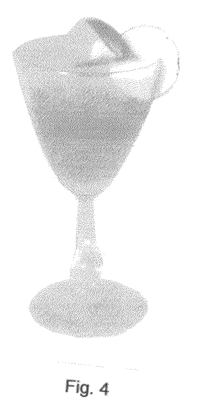

1. A flat utensil with two tines and a slot at a right angle there to.

2. A utensil of variable thickness with two tines and a variable slot at an angle there to.

3. A utensil with a variable width slot to accommodate different containers.
